(19) United States
(12) Patent Application Publication
(10) Pub. No.: US 2018/0254696 A1
(43) Pub. Date: Sep. 6, 2018

(54) Power Supply for Welding and Cutting Apparatus

(71) Applicant: The ESAB Group Inc., Florence, SC (US)

(72) Inventors: Rodrigo Cesar Salum MACHADO, Florence, SC (US); Pranav P. SANGHAVI, Ellicott City, MD (US); Suneesh THOVARAYI, Florence, SC (US); Binod YADAV, Florence, SC (US); Hardik S. SHAH, Florence, SC (US); Awad GHARIB, Florence, SC (US); Muniswamappa ANJANAPPA, Florence, SC (US)

(21) Appl. No.: 15/915,382

(22) Filed: Mar. 8, 2018

Related U.S. Application Data
(63) Continuation of application No. PCT/US2016/052073, filed on Sep. 16, 2016.
(60) Provisional application No. 62/220,555, filed on Sep. 18, 2015.

(51) Int. Cl. H02M 1/42; B23K 9/10

(52) U.S. Cl. CPC H02M 1/4225; H02M 7/06; B23K 9/1006

(57) ABSTRACT

A power supply to provide welding or cutting power. The power supply may include an input rectifier to receive an AC input voltage from an input mains and output a rectified DC signal; a PFC/boost block to receive the rectified DC signal and output a boost DC signal having a predetermined voltage independent of the AC input voltage; an inverter to receive the boost DC signal, and output AC power to an output transformer; a PFC controller to control operation of the PFC/boost block; a control block to control operation of the inverter; an internal power supply to receive the rectified DC signal and output a first DC power signal to power the PFC controller, and output a second DC power signal to power the control block.

### RELATED APPLICATIONS

This application is a Continuation of PCT/US2016/052073 filed on Sep. 16, 2016, which PCT claims the benefit of U.S. Provisional Patent Application No. 62/220,555, filed Sep. 18, 2015, both of which are incorporated by reference herein in their entirety.

### TECHNICAL FIELD

The present embodiments are related to power supplies for welding type power, that is, power generally used for welding, cutting, or heating.

### BACKGROUND

In welding apparatus, welding power may be derived from an AC mains supplying power at a voltage of 90 V or greater, for example. In different settings, the AC voltage delivered by the AC mains to the welding apparatus may be different. Known welding apparatus may convert voltage received from the AC mains to a fixed output voltage independent of the AC input voltage received from the mains. This fixed output voltage may be a high voltage such as 500 V, 700 V, or other target voltage, where the fixed output voltage is output through a transformer to reduce the voltage for providing welding power. Power received from the AC mains may also be harnessed to power various components including controllers within a welding apparatus.

It is with respect to these and other considerations that the present disclosure is provided.

### BRIEF SUMMARY

In one embodiment, a power supply to provide welding or cutting power is disclosed. The power supply may include an input rectifier to receive an AC input voltage from an input mains and output a rectified DC signal; a PFC/boost block to receive the rectified DC signal and output a boost DC signal having a predetermined voltage independent of the AC input voltage; an inverter to receive the boost DC signal, and output AC power to an output transformer; a PFC controller to control operation of the PFC/boost block; a control block to control operation of the inverter; an internal power supply to receive the rectified DC signal and output a first DC power signal to power the PFC controller, and output a second DC power signal to power the control block.

In another embodiment, a method of operating a power supply may include rectifying an AC input voltage to output a rectified DC signal; boosting the rectified DC signal using a power factor correction (PFC)/boost block to output a boost DC signal having a predetermined voltage independent of the AC input voltage; inverting the boost DC signal to generate AC power; controlling operation of the PFC/boost block using a PFC controller; controlling operation of the inverter using a control block; and from an internal power supply, outputting a first DC power signal to power the PFC controller, and outputting a second DC power signal to power the control block based upon the rectified DC signal.

### DESCRIPTION OF FIGURES

FIG. 1 depicts a block diagram of an exemplary apparatus according to embodiments of the disclosure.

FIG. 2A depicts a more detailed circuit diagram of an embodiment of the apparatus of FIG. 1.

FIG. 2B to FIG. 2C illustrate respective portions of the apparatus of FIG. 1.

### DESCRIPTION OF EMBODIMENTS

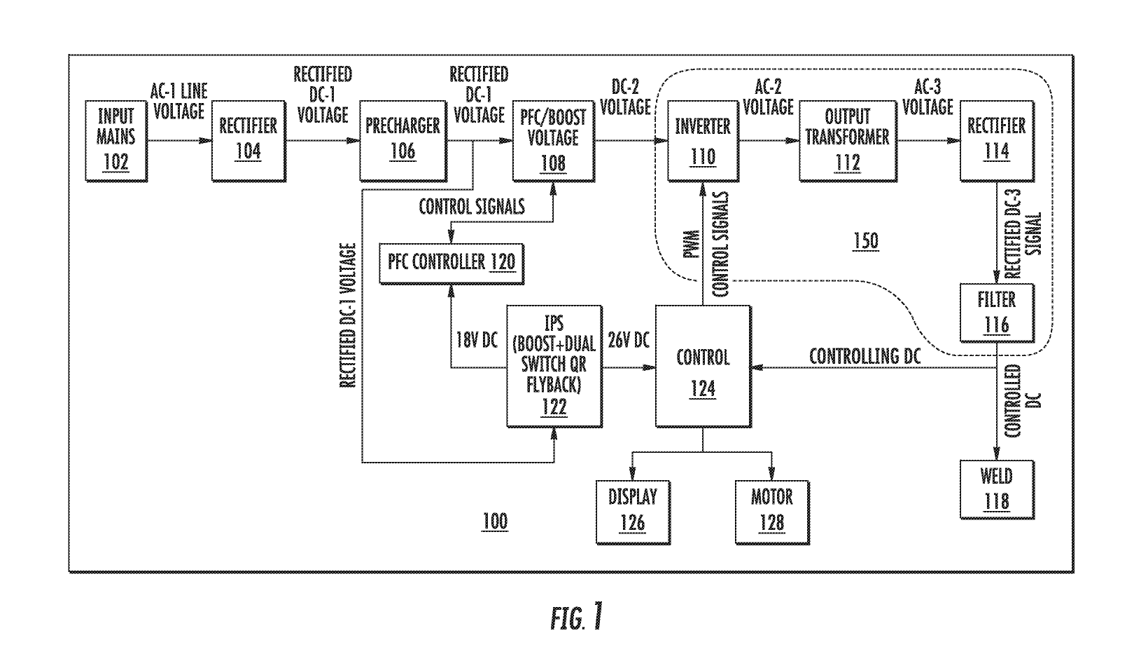

The present embodiments provide improvements over conventional apparatus used to provide power for welding or cutting. FIG. 1 depicts a block diagram of an apparatus 100 according to embodiments of the disclosure. The apparatus 100 includes components of a power supply and related components for use in a welding system or cutting system. The power supply is designed to provide welding power or cutting power and power to operate other components based upon an input alternating current (AC) power source. In particular, apparatus 100 is designed to operate using AC voltage at different operating voltages, where the AC voltage may be received via the input mains 102. In some embodiments, the input voltage may range over a range of voltages, such as between 90 V and 270 V AC. The embodiments are not limited in this context. The Apparatus 100 may include an input rectifier, shown as rectifier 104. The rectifier 104 is configured to receive an “AC-1” line voltage from input mains 102, where the mains 102 carry AC power. A DC voltage, shown as “Rectified DC-1” voltage is produced when the rectifier 104 receives AC voltage from the input mains 102, and rectifies the AC voltage. More particularly, the rectifier 104 generates a rectified DC-1 voltage that is passed through a precharger 106 that outputs the Rectified DC-1 voltage.

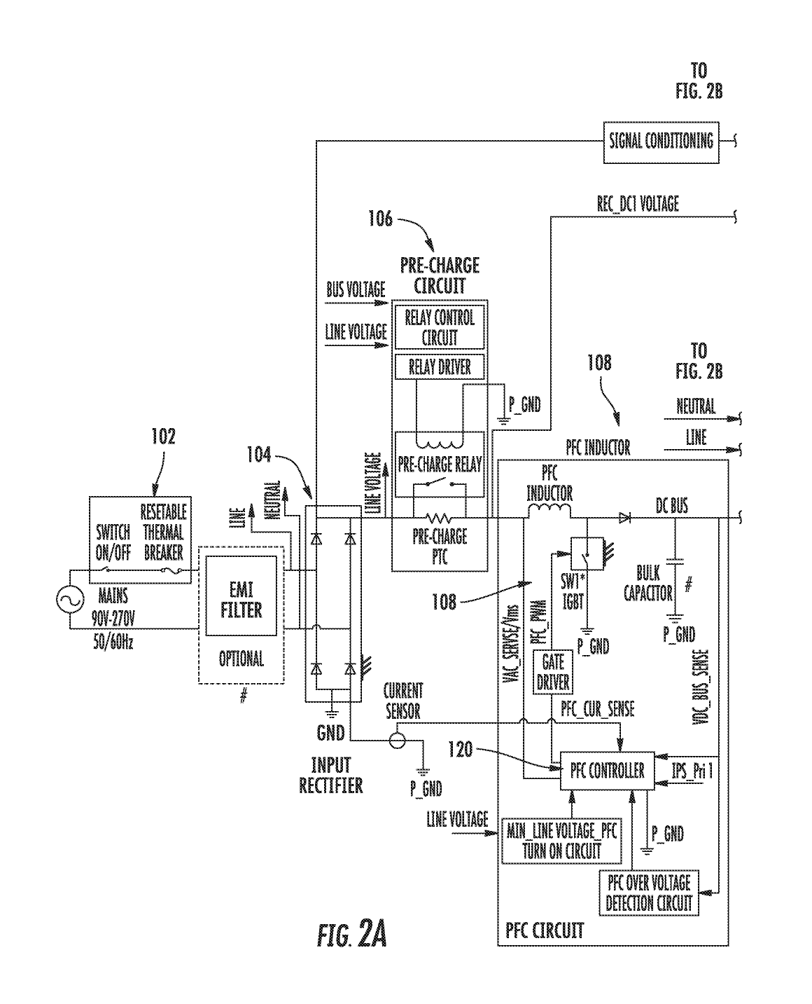

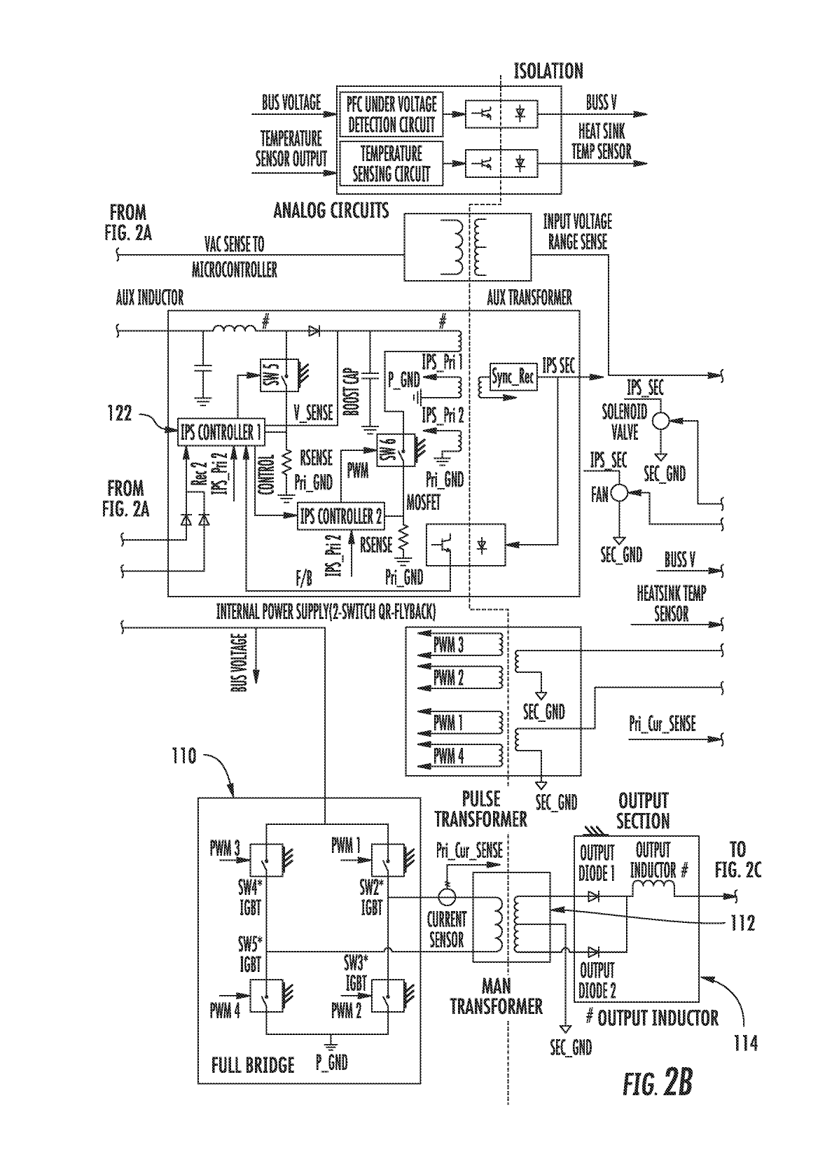

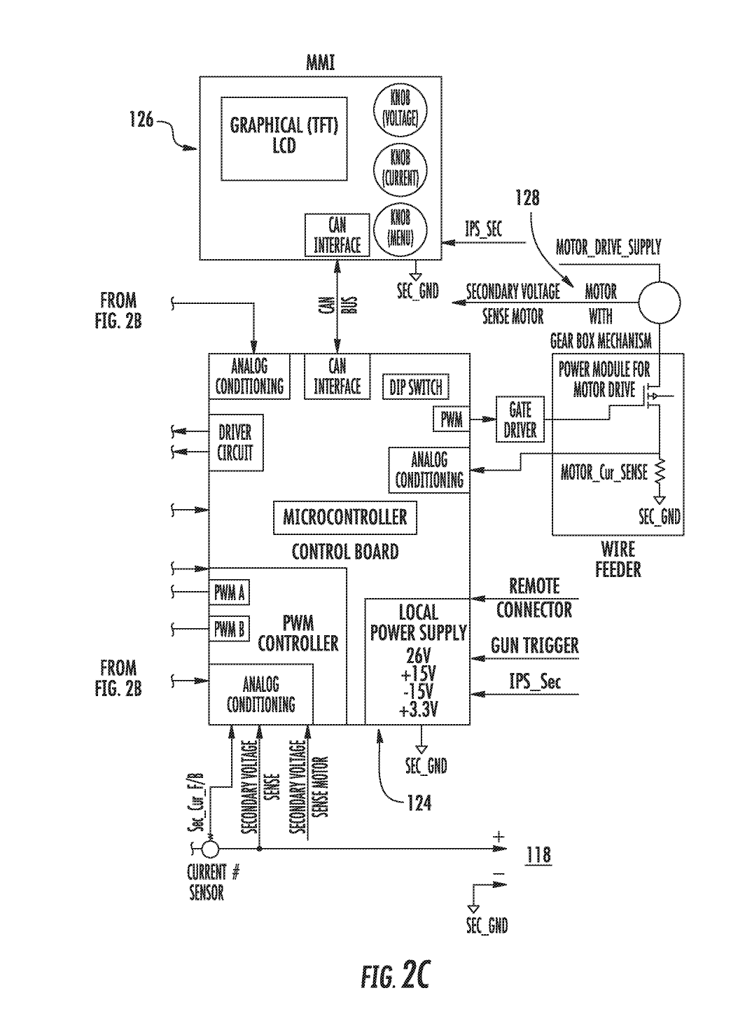

As further shown in FIG. 1, the apparatus 100 also includes a voltage booster shown as PFC/boost voltage block 108 that is configured to receive the Rectified DC-1 voltage and output a constant “boosted” DC voltage, the “DC-2” voltage. Further details of an embodiment of the PFC/boost voltage block 108 are shown, for example, at FIG. 2A. As shown therein, the PFC/boost voltage block 108 may include a power factor correction (PFC) inductor, switch SW1*IGBT, and diode. In various embodiments, the DC-2 voltage may be greater than 500 V.

The apparatus 100 also includes a PFC controller 120 that controls operation of the PFC/Boost voltage block 108. In particular, as shown in FIG. 2A, the switch SW1*IGBT is controlled by the PFC controller 120 via the Gate driver component. In this manner the switch SW1*IGBT acts to increase the voltage of the Rectified DC-1 signal. The DC-2 voltage that is output by the PFC/Boost voltage block 108 is greater than the voltage of the Rectified DC-1 voltage and is not dependent upon the magnitude of the Rectified DC-1 voltage or the voltage of the input mains 102. The PFC controller 120 also acts to perform power factor correction on the Rectified DC1 signal that is received by the PFC/Boost voltage block 108.

The apparatus 100 further includes an output circuit 150. The output circuit 150 includes inverter 110, where the inverter 110 receives the DC-2 voltage (DC Bus) and outputs AC power, shown as “AC-2” voltage, to an output transformer 112. The output transformer 112 outputs power to the rectifier 114 for generating welding power. In particular, the rectifier 114 outputs a rectified voltage shown as “Rectified DC-3” signal to a filter 116, where the filter 116 outputs a signal to the weld block 118. As shown in FIG. 2A, the inverter 110 may be configured as a full bridge having four switches whose operation is controlled by a control block 124. The control block 124 may send respective pulse width modulation signals to the switches of inverter 110 to generate a target AC output from inverter 110, according to generally known principles.

The apparatus 100 also includes an internal power supply (IPS) 122 that draws power from the Rectified DC1 voltage. The IPS 122 may include a quasi-resonant flyback converter that may output different voltages. In particular, the IPS 122 is configured to provide DC power signals to various components of the apparatus 100. The IPS 122 may input a first DC power signal to control a PFC controller 120 and a second DC power signal to control the control block 124, where the first DC power signal and second DC power signal comprise a low voltage, such as less than 40 V. In an embodiment shown below, the IPS 122 outputs an 18 V DC signal to the PFC controller 120 and a 26V DC signal to the control block 124 that controls the operation of inverter 110. The control block 124 may, in addition to controlling the inverter 110, send signals to control a display 126 and motor 128.

As shown in FIGS. 2A-2C, in one embodiment the IPS 122 may receive the Rectified DC1 voltage and output an IPS PRi_1 signal to power the PFC controller 120, where the IPS Pri_1 signal may be 18 V DC in some embodiments. The IPS 122 may also output an IPS_Sec at 18 V DC to the controller block 124, as shown. The IPS_Sec signal may also be sent to a fan and a display, as shown, for example in FIG. 2B. The apparatus 100 thus provides a flyback converter to be used to receive a rectified voltage and to supply power for various components of the apparatus 100.

In addition, the IPS 122 may output an IPS Sec signal, where the IPS Sec signal is transmitted to the control block 124. As shown, the IPS Sec signal may be sent to a local power supply for the control block 124. In turn, the control block 124 may include a Pulse width modulation (PWM) controller as shown. The PWM controller may provide control signals to control operation of the inverter 110. As shown, a series of control signals (PWM control signals) may be generated from the PWM controller and sent to the inverter 110 via a pulse transformer, where the pulse transformer outputs a PWM1 signal, PWM2 signal, PWM3 signal, and PWM4 signal, where these control signals control the operation of a set of solid state switches in the inverter 110, where the solid state switches may be insulated gate bipolar switches, as in known inverters.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Thus, the claims set forth below should be construed in view of the full breadth and spirit of the present disclosure as described herein.

What is claimed is:

1. A power supply to provide welding or cutting power, comprising:
an input rectifier to receive an AC input voltage from an input mains and output a rectified DC signal;
a PFC/boost block to receive the rectified DC signal and output a boost DC signal having a predetermined voltage independent of the AC input voltage;
an inverter to receive the boost DC signal, and output AC power to an output transformer;
a PFC controller to control operation of the PFC/boost block;
a control block to control operation of the inverter; and
an internal power supply to receive the rectified DC signal and output a first DC power signal to power the PFC controller, and output a second DC power signal to power the control block.

2. The power supply of claim 1, wherein the input rectifier is coupled to receive the AC input voltage over a range of voltages.

3. The power supply of claim 2, wherein the range of voltages is between 90 V and 270 V.

4. The power supply of claim 1, wherein the first DC power signal and second DC power signal comprise a voltage of less than 40 V.

5. The power supply of claim 1, wherein the inverter comprises a full bridge, the full bridge comprising a plurality of solid state switches, and wherein the control block generates a plurality of pulse width modulation (PWM) control signals, the PWM control signals controlling operation of the plurality of solid state switches.

6. The power supply of claim 1, wherein the internal power supply comprises a quasi-resonant flyback converter.

7. A method of operating a power supply, comprising:
rectifying an AC input voltage to output a rectified DC signal;
boosting the rectified DC signal using a power factor correction (PFC)/boost block to output a boost DC signal having a predetermined voltage independent of the AC input voltage;
inverting the boost DC signal to generate AC power;
controlling operation of the PFC/boost block using a PFC controller;
controlling operation of the inverter using a control block; and
from an internal power supply, outputting a first DC power signal to power the PFC controller, and outputting a second DC power signal to power the control block based upon the rectified DC signal.

8. The method of claim 7, wherein the AC input voltage is received by an input rectifier coupled to receive the AC input voltage over a range of voltages.

9. The method of claim 8, wherein the range of voltages is between 90 V and 270 V.

10. The method of claim 7, wherein the first DC power signal and second DC power signal comprise a voltage of less than 40 V.

11. The method of claim 7, wherein the inverter comprises a full bridge, the full bridge comprising a plurality of solid state switches.

12. The method of claim 7, wherein the internal power supply comprises a quasi-resonant flyback converter.
